(19) United States
(12) Patent Application Publication
(10) Pub. No.: US 2003/0128297 A1
(43) Pub. Date: Jul. 10, 2003

(54) Device for dividing and shifting TV picture and its operating method

(75) Inventor: Zhi-Wei Chu, Taipei (TW)

Correspondence Address: BRUCE H. TROXELL, SUITE 1404, 5205 LEESBURG PIKE, FALLS CHURCH, VA, 22041, US

(73) Assignee: Kinpo Electronics, Inc.

(21) Appl. No.: 10/035,314

(22) Filed: Jan. 4, 2002

(51) Int. Cl. H04N 5/44; H04N 5/445; H04N 9/74

(52) U.S. Cl. 348/564; 348/561; 348/563; 348/588

(57) ABSTRACT

This invention relates to a device for dividing and shifting television picture and its operating method, which comprises a Set Top Box and a controller both connected to a television; the Set Top Box capably converts input analog video signal to the television into output digital video signal to display video picture capably divided into a contracted picture and a controlled picture on the screen, and once the television is switched on, the television screen is always displayed said contracted picture and said controlled picture simultaneously; and the controller have a controlling key used to divide and shift TV picture, when said controlling key is pushed the video picture is displayed into full size on the television screen.

### BACKGROUND OF THE INVENTION

1. Field of the Invention

The present invention relates to division of television picture and more particularly to a television videos capably divided into a contracted video picture and a controlled picture once the television is switched on, and by a controller the user can select whether the videos to be displayed on screen in full size or not.

2. Description of Related Art

The television is so popularized to all people now that it becomes an essential instrument for people used to read or know any kind of information and to watch or enjoy any entertainment program shown on it. Therefore, there are several inventions invented to improve some useful functions to television, for example, Taiwanese Patent Publication No. 379502 is disclosed a multi-picture television receiver wherein a main picture by a first video signal of a first video system and a sub-picture by a second video signal of a second video system can be displayed simultaneously on the screen, and another Taiwanese Patent Publication No. 297204 is disclosed a television receiver capably adjustable picture size wherein a remote controller is used to emit signal for adjusting the ratio of picture width displayed on the screen. As according to the disclosed contents of above-mentioned two Taiwanese Patents, it is obvious that the technology of two different pictures capably displayed simultaneously on the screen and the picture size capably adjustable are already known as prior art. Moreover, at present a kind of motion AD Banner probably to show an instantaneous news or advertisement is designed to be shown in motion way and displayed by way of overlaying on the picture of TV program, but the TV user, if feeling interference, can not selectively delete the motion AD Banner intentionally. And now the TV used as display screen is capably connected to mainframe of computer to display homepage of Internet, but it is can not directly shift back to show the general picture of TV program once used in Internet situation.

### SUMMARY OF THE INVENTION

This present invention is disclosed to provide more practical functions to TV use, and especially capably match the development of Internet's technology to promote TV function.

The primary objective of this present invention is to provide a device for dividing and shifting television picture and its operating method, to make television video picture capably divided into a contracted video picture and a controlled picture once the television is switched on.

The another objective of this present invention is to provide a device for dividing and shifting television picture and its operating method, to make TV user intentionally to selectively shift the television picture into full screen size or into divided pictures included a contracted video picture and a controlled picture.

### BRIEF DESCRIPTION OF THE DRAWINGS

The invention is description in detail with reference to the following drawings, wherein like numerals represent like elements:

FIG. 1 is of a block diagram of the first embodiment of this present invention.

FIG. 2 is a block diagram of the second embodiment of this present invention.

FIG. 3 is shown a contracted video picture and a controlled picture of this present invention simultaneously displayed on TV screen.

FIG. 4 is shown the television picture of this invention displayed into full screen size.

### DETAILED DESCRIPTION OF THE PREFERRED EMBODIMENT

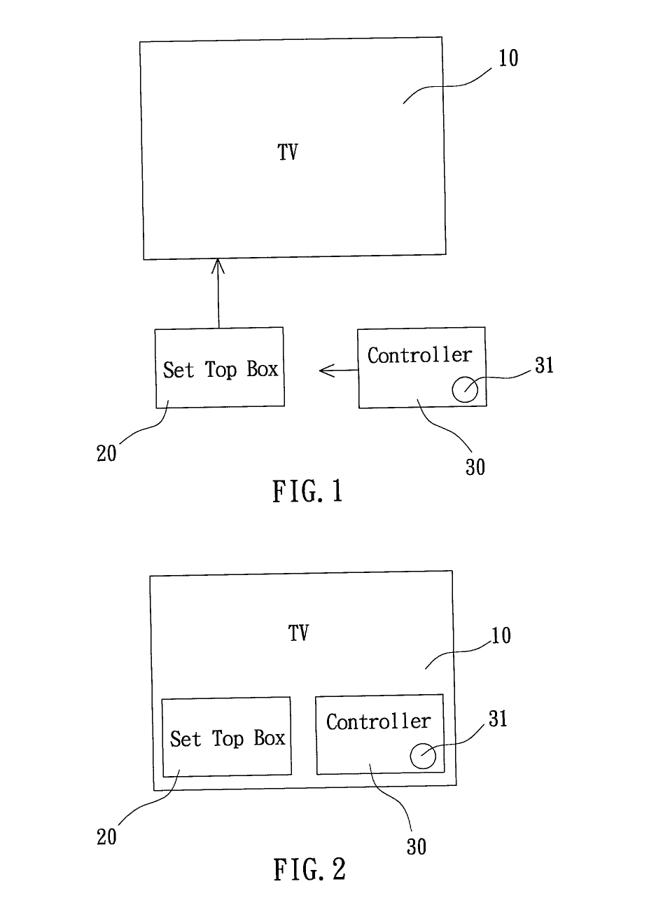

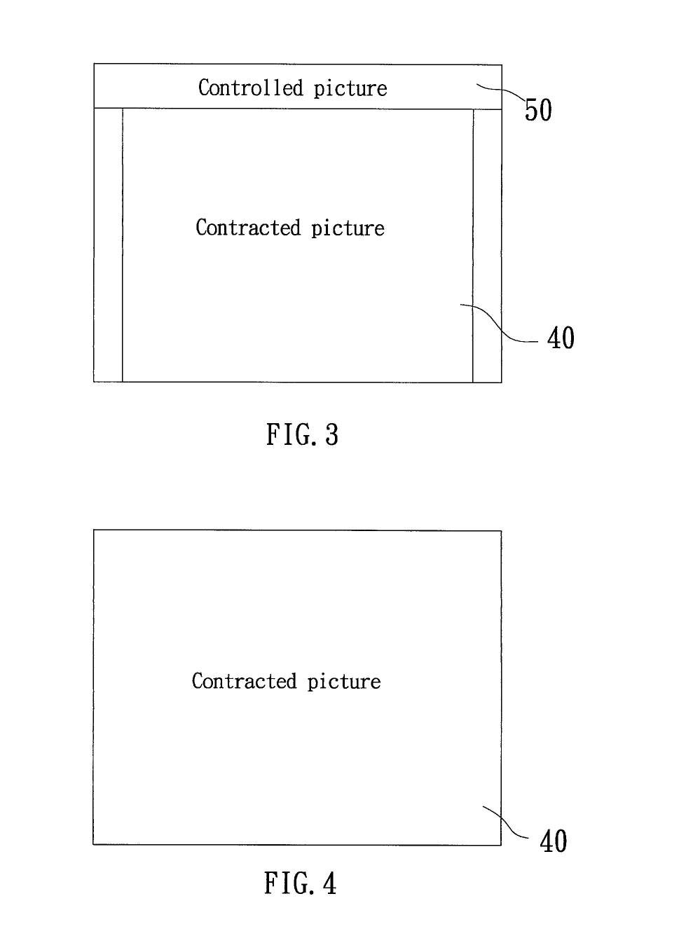

Referring to FIG. 1, FIG. 2 and FIG. 3 this invention is disclosed a TV 10 separately connected to a Set Top Box 20 and a controller 30 as the first embodiment of this present invention. Which Set Top Box 20 is used to convert input analog video signal to the television 10 into output digital video signal to display video picture capably divided into a contracted picture 40 and a controlled picture 50 on the TV screen shown as FIG. 3. Once the television is switched on, the TV screen is always shown said contracted picture 40 and said controlled picture 50. Said controller 30 of the first embodiment of this invention is a remote controller provided with multiple keys and a controlling key 31 used to divide and shift TV picture.

Referring to FIG. 2, this invention is disclosed a TV 10, a Set Top Box 20, and a controller 30 are connected together as a whole as the second embodiment of this present invention.

The method of this invention to divide and shift television picture is provided the TV screen operation will be controlled by a Set Top Box 20 to display a contracted picture 40 and a controlled picture 50 when the TV is switched on by TV user with a controller 30. A signal, emitted from said controller 30 When the controlling key 31 arranged onto said controller 30 is pushed by said TV user, is once received to said Set Top Box 20 then to control and shift the picture 40 shown on TV screen size in (100%) full screen size. Once said controlling key 31 is pushed by TV user again, the picture shown on TV screen is shifted and displayed as a contracted picture 40 with 86% contraction ratio and a controlled picture 50 again.

The area of said contracted picture 40 of this present invention is used to display general TV program show or display homepage of Internet when TV is connected to computer; and the area of controlled picture 50 is used to display Tool Bar as in general shown on computer monitor and/or display AD Banner. To enter computer system, if TV is connected to mainframe of computer, the TV user can take use of the Tool Bar shown on said controlled picture 50 to selectively push those keys of controller 30 corresponding to Tool Bar, otherwise the TV screen is selected to display TV Picture presented in TV system. The TV is capably used as general computer monitor when TV system is selectively shifted to computer system by said TV user to display homepage of Internet. At this moment the TV user through the Tool Bar shown on controlled picture 50 of TV screen can browse any Internet provider in Internet, and said TV user can jut selectively shift back to TV system also.

The present invention can be provided to TV business, cable TV business and TV provider which can output any information such as advertisement on the controlled picture 50 so that the service fee charged to the TV user can be divided into several different levels according to the TV user whether needed to receive the above-mentioned information or not; therefore, the TV user who by himself/herself selectively receive the TV program show with or without said controlled picture 50 by controller 30 may be free or pay a lower cost to enjoy the TV program show, or pay a higher cost by way of the controlled picture 50 to browse Internet provider.

The present invention can also be provided to general hotel or restaurant business where provides TV for customer used in every room, so that the customer can use the controlled picture 50 shown the TV screen once the TV switched on to browse Internet provider. The fee of browsing Internet used by customer could be paid according to whether browsing Internet capably divided into several different levels. The TV user who by himself/herself selectively receive the TV program show with or without said controlled picture 50 by controller 30 may be free or pay a lower cost to enjoy the TV program show, or pay a higher cost by way of the controlled picture 50 to browse Internet provider.

The scope of this disclosed invention is not limited to the embodiment illustrated as above. Which scope explained and defined by claims may include all changeable equivalents more particularly only changed in easy amendment or variation.

What is claimed is:

1. A device for dividing and shifting television picture comprises a TV, a Set Top Box connected said TV and a controller wherein said Set Top Box capably converts input analog video signal to the television into output digital video signal to display video picture capably divided into a contracted picture and a controlled picture on the screen, and once the television is switched on, the television screen is always displayed said contracted picture and said controlled picture simultaneously; and said controller have a controlling key used to divide and shift TV picture, when said controlling key is pushed the video picture is displayed into full size on the television screen.

2. The device for dividing and shifting television picture as defined by claim 1, wherein said controlled picture comprises a Tool Bar.

3. The device for dividing and shifting television picture as defined by claim 1, wherein said controlled picture comprises a AD Banner.

4. The device for dividing and shifting television picture as defined by claim 1, wherein said controlled picture comprises a Tool Bar and a AD Banner.

5. The device for dividing and shifting television picture as defined by claim 4, wherein said controller is a remote controller.

6. The device for dividing and shifting television picture as defined by claim 4, wherein said TV, said Set Top Box and said controller are connected together as a whole.

7. The device for dividing and shifting television picture as defined by claim 5, wherein said contracted picture is with 86% contraction ratio to full screen size.

8. A operating method for dividing and shifting television picture comprise the following steps:
(a)the operation of TV screen displayed can be controlled by a Set Top Box to display a contracted picture and a controlled picture on TV screen, when the TV is switched on by TV user with a controller; and
(b)A signal, emitted from said controller When the controlling key of said controller is pushed by a TV user, is once received to said Set Top Box then to control and shift the picture shown on TV screen size in full screen size.

9. The operating method for dividing and shifting television picture as defined in claim 8, wherein said controlled picture comprises a Tool Bar.

10. The operating method for dividing and shifting television picture as defined in claim 8, wherein said controlled picture comprises a AD Banner.

11. The operating method for dividing and shifting television picture as defined in claim 8, wherein said controlled picture comprises a Tool Bar and a AD Banner.

12. The operating method for dividing and shifting television picture as defined in claim 11, wherein said contracted picture is with 86% contraction ratio to full screen size.

13. The operating method for dividing and shifting television picture as defined in claim 12, wherein Once said controlling key is pushed by said TV user again, the picture shown on TV screen is shifted and displayed as said contracted picture and said controlled picture again.

14. The operating method for dividing and shifting television picture as defined in claim 11, wherein the area of said contracted picture is used to display general TV program show.

15. The operating method for dividing and shifting television picture as defined in claim 11, wherein by way of Tool Bar shown on said controlled picture the TV user can operate the key of said controller to selectively shift the TV screen as computer system otherwise the TV screen is selected to display TV Picture presented in TV system.
